(19) United States
(12) Patent Application Publication
(10) Pub. No.: US 2024/0041074 A1
(43) Pub. Date: Feb. 8, 2024

(54) APPARATUS AND METHOD FOR PROCESSING KELP

(71) Applicant: BLUE DOT KITCHEN, SPC, BAINBRIDGE ISLAND, WA (US)

(72) Inventor: Travis Bettinson, Bainbridge Island, WA (US)

(73) Assignee: BLUE DOT KITCHEN, SPC, BAINBRIDGE ISLAND, WA (US)

(21) Appl. No.: 18/364,445

(22) Filed: Aug. 2, 2023

Related U.S. Application Data
(60) Provisional application No. 63/370,249, filed on Aug. 3, 2022.

(51) Int. Cl. A23L 5/30; A23L 17/60; A23P 10/25; A23P 30/00

(52) U.S. Cl. CPC A23L 5/30; A23L 17/60; A23P 10/25; A23P 30/00

(57) ABSTRACT

Disclosed is an apparatus for processing kelp comprising a material chamber, a stripper peg inside the material chamber, a shaft, wherein a portion of the shaft has threads for urging kelp forward, wherein the threads have notches in the outside edge of the threads, a perforated screen, an outer screen, a support beam, an outlet, and a faceplate. The apparatus can be used for a method to remove iodine from kelp using non-chemical means.

### I. BACKGROUND

The present disclosure pertains to the art of kelp processing. More specifically, to processing kelp using mechanical means.

Kelp has a relatively high iodine concentration. The iodine concentration is usually reduced by chemical processing. However, the chemical processing of kelp makes it undesirable for some consumers who are buying kelp food products. Further, the chemical processing of kelp can destroy quality nutrients. Some consumers desire for their kelp to not be chemically processed. What is desired is a method to remove iodine from kelp using non-chemical means.

### II. SUMMARY

In accordance with one aspect of the present disclosure, an apparatus for processing kelp comprising: a material chamber, a stripper peg inside the material chamber, a shaft, wherein a portion of the shaft has threads for urging kelp forward, wherein the threads have notches in the outside edge of the threads, a perforated screen, an outer screen, a support beam, an outlet, and a faceplate.

In accordance with another aspect of the present disclosure, a method for processing kelp comprising: adding kelp into a material chamber, urging the kelp forward with a shaft with threads, pressing the kelp against at least one tooth, at least one thread, at least one shaft, and at least one perforated screen to create kelp liquor, collecting the kelp liquor, optionally repeatedly pressing the kelp and collecting, urging the kelp through an outlet, and collecting a press cake. This method efficiently processes the kelp and significantly reduces the iodine concentration in the press cake. Further, this method does this without using chemical means.

In accordance with another aspect of the present disclosure, a method for processing kelp comprising adding kelp into a material chamber, urging the kelp forward with a shaft with threads, pressing the kelp against at least one tooth, at least one thread, at least one shaft, and at least one perforated screen to create kelp liquor, collecting the kelp liquor, optionally repeatedly pressing the kelp and collecting, urging the kelp through an outlet, collecting a press cake, collecting a kelp cake and a kelp liquor, injecting steam into the perforated screen to at least partially cook the kelp while it passes through the perforated screen, and adding a carrier agent to the kelp liquor.

In accordance with another aspect of the present disclosure, a press cake that may have an iodine content that is from about 60% to about 67%, where the iodine content is based on the weight of iodine in the press cake versus the weight of the unprocessed kelp.

In accordance with another aspect of the present disclosure, a kelp liquor that may have an iodine content that is from about 40% to about 33%, where the iodine content is based on the weight of iodine in the kelp liquor versus the weight of the unprocessed kelp.

In accordance with another aspect of the present disclosure a kelp processing method as described above, wherein the kelp processing method yields kelp cake comprising 45%-50% iodine.

Still other discoveries, benefits, and advantages of the disclosure will become apparent to those skilled in the art to which it pertains.

### III. BRIEF DESCRIPTION OF THE FIGURES

The present disclosure may take physical form in certain parts and arrangement of parts, aspects of which will be described in detail in this specification and illustrated in the accompanying figures which form a part hereof and wherein:

FIG. 1 is a diagram of kelp processing apparatus 20.

FIG. 2 is a view looking down into material chamber 30.

FIG. 5 is a view looking down into material chamber 30 with stripper peg 46.

FIG. 3 is a front perspective view focusing on the filtration process.

FIG. 4 is a front perspective view focusing on press cake 50.

FIG. 6 is a close view of the notches 86 on the shaft 40 threads 44.

FIG. 7 is a front perspective view focusing on the filtration process, with a steam injector 84.

### IV. DETAILED DESCRIPTION

Referring now to the figures wherein the showings are for purposes of illustrating aspects of the present disclosure only and not for purposes of limiting the same, and wherein like reference numerals are understood to refer to like components.

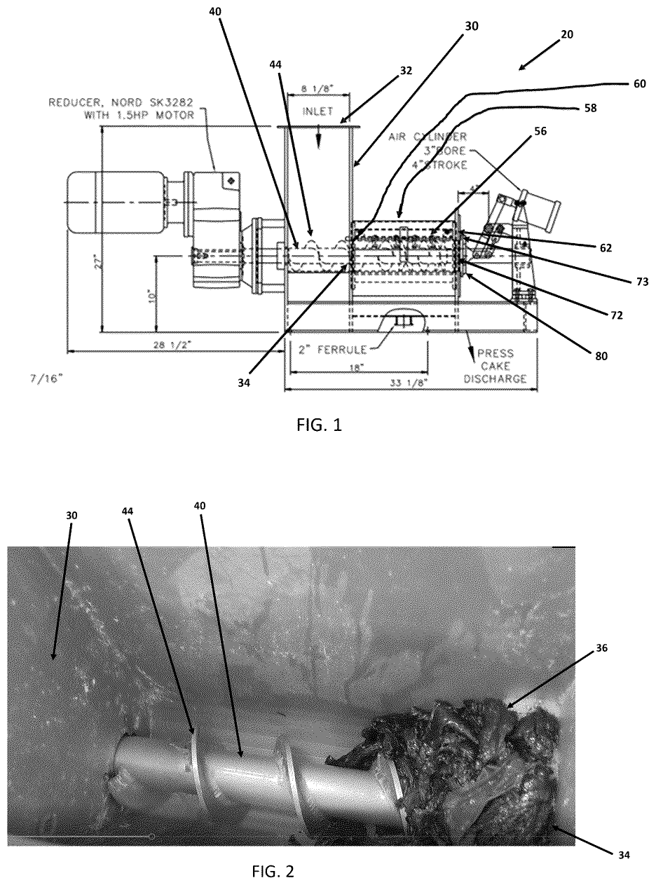

Referring to FIG. 1, a kelp processing apparatus 20 is shown. In some aspects of the present disclosure, kelp processing apparatus 20 is a screw press with modifications specifically for processing kelp. FIG. 1 shows material chamber 30, material chamber inlet 32, shaft 40, threads 44, and faceplate 80.

With reference to FIGS. 1, 2, and 6, in some aspects of the present disclosure kelp processing apparatus 20 includes material chamber 30. Material chamber 30 houses a portion of shaft 40. Shaft 40 may extend from outside of material chamber 30, into the chamber, and out of material chamber exit aperture 34. As best shown in FIG. 1, shaft 40 extends throughout kelp processing apparatus 20. Shaft 40 may only have threads 44 on a portion of it. Shaft 40 may stop having threads once it enters outlet 72. Threads 44 may have notches 86 on their edges. This can increase the throughput of kelp processing apparatus 20 and enable kelp processing apparatus 20 to shred kelp more efficiently.

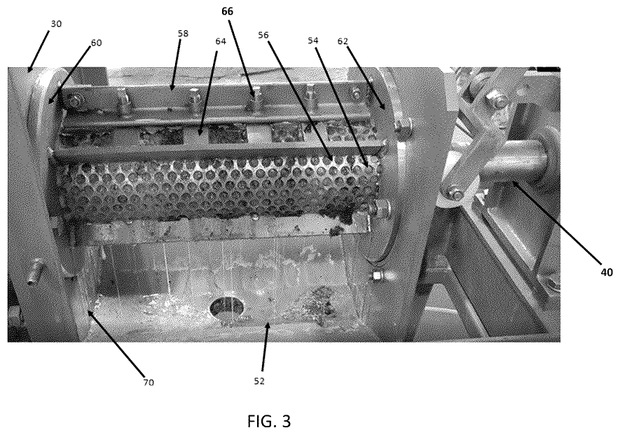

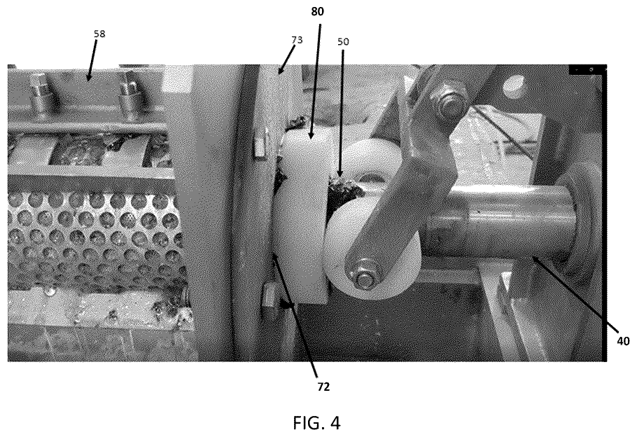

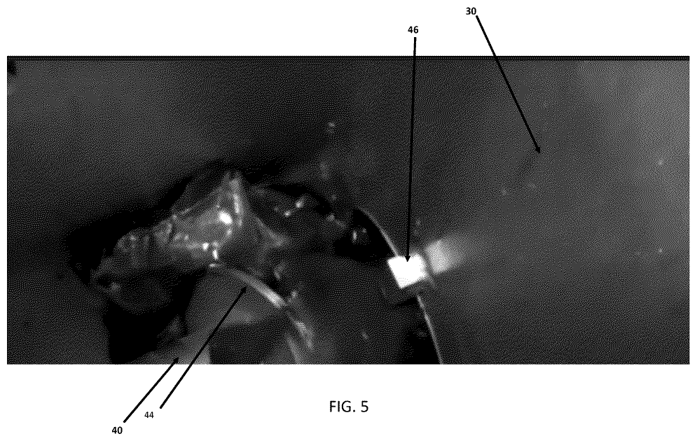

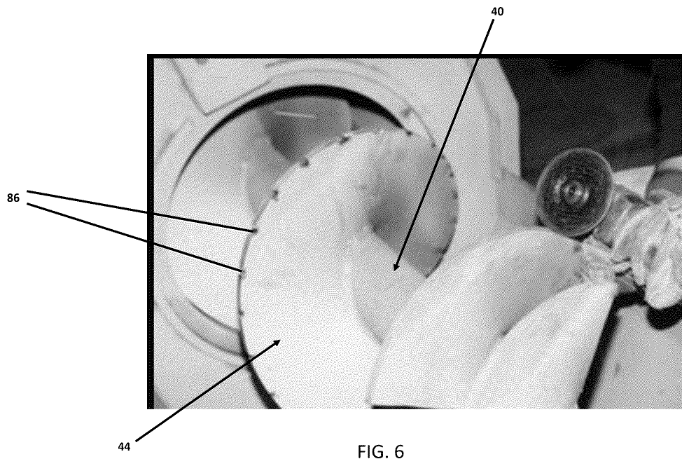

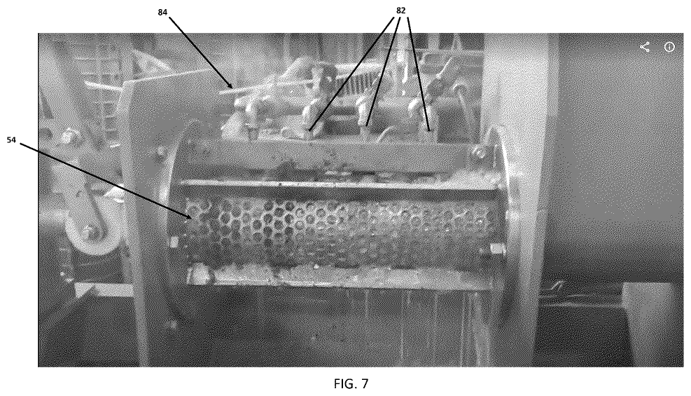

With reference to FIGS. 1 and 2, a user can add kelp 36 into material chamber via material chamber inlet 32. When kelp processing apparatus 20 is powered and shaft 40 is turning, kelp 36 is urged forward and out of material chamber exit aperture 34 by threads 44.

In one or more aspects of the present disclosure, kelp 36 may be Laminaria saccharina. In other aspects of the present disclosure, kelp 36 may be Sacharrina latissimi, Alaria escuelenta, Alaria marginate, Macrocystis pyrifera, Nereocystis luetkeana, Palmaria palmata, Ulva lobata, Laminaria japonica, or Saccharina japonica, or a combination of these types.

With reference to FIG. 2A, kelp processing apparatus 20 includes stripper peg 46. Alginates in kelp can hinder the ability of threads 44 to move kelp 36 forward. This problem is solved by using stripper peg 46 to shred kelp 36 so it can move forward. Stripper peg 46 may be attached by welding it to a material chamber wall 31 of material chamber 30. Stripper peg 46 may be positioned so that front thread 45 of shaft 40 touches stripper peg 46 as front thread 45 rotates on shaft 40. This touching may be continuous or for a brief moment. One discovery in the present disclosure is that if stripper peg 46 is positioned so that it touches front thread 45, it shreds kelp 36. Kelp 36 may be shredded by contact between stripper peg 46 and front thread 45.

With reference to FIG. 3, kelp processing apparatus 20 performs a filtration process. The process takes kelp 36 and filters it to create press cake 50 and kelp liquor 52. FIG. 3 shows perforated screen 54 and outer screen 56. Shaft 40 with threads 44 runs through perforated screen 54 and through the rest of kelp processing apparatus 20. In one or more aspects of the present disclosure, perforated screen 54 has a porosity of about 0.033 inch, and in another, 0.050 inch. In one or more aspects of the present disclosure, perforated screen 54 may have a porosity from about 0.033 inch to about 0.050 inch, in another from about 0.040 inch to about 0.045 inch. The use of a perforated screen with a porosity of more than 0.050 inch may be detrimental and reduce filter efficiency.

Perforated screen 54 and outer screen 56 are connected to support bar 58. The connection takes place underneath support bar 58 and the top of outer screen 56. Support bar 58 has one or more teeth 59. One or more teeth 59 are positioned to be inside of perforated screen 54 for pressing kelp 36 against perforated screen 54. Perforated screen 54 and outer screen 56 have apertures for teeth 59 to protrude through.

Support bar 58 is connected to material chamber ring 60 and filtration ring 62. In one or more aspects of the present disclosure, perforated screen 54 and outer screen 56 may be connected to more than one support bar 58. In one or more aspects, support bar 58 is connected to frame 64. Frame 64 is adapted to form around outer screen 56. In one or more aspects of the present disclosure, outer screen 56 is connected to support bar 58 via one or more threaded bolt 66. Additionally, outer screen 56 may be connected to frame 65 and support bar 58 via one or more threaded bolt 66.

In one or more aspects, and with reference to FIG. 7, kelp processing apparatus 20 has steam injector 84 for injecting steam into perforated screen 54. Injecting steam into perforated screen 54 while kelp 36 is moving through it can cook kelp 36. This helps to control the iodine and the nutrient content of press cake 50 and kelp liquor 52. Further, injecting steam to cook kelp 36 can control the moisture and viscosity of press cake 50. Steam is delivered into the perforated screen through the ports 82. Pipes with valves are attached to ports 82. The pipes are connected on another side to a steam generator.

The filtration process may be as follows: first, kelp 36 is urged through material chamber exit aperture 34 by shaft 40 with threads 44 and into the inside of perforated screen 54. As the kelp 36 is urged forward by threads 44, it becomes pressed against at least one tooth 59, thread 44, shaft 40, and perforated screen 52. This squeezes kelp 36 and extracts liquids. This squeezing process may occur multiple times with subsequent teeth 59 as threads 44 continue to move kelp 36 forward along in kelp processing apparatus 20. Once kelp 36 has passed the last tooth 59, it is urged by threads 44 forward and out of outlet 72.

With continuing reference to FIG. 3, when kelp is processed, the kelp liquor 52 is collected in liquor container 70. Liquor container 70 may be a tub; further, it may sit below outer screen 56. In one or more aspects of the present disclosure, liquor container 70 may also be a pipe 71. Pipe 71 would be positioned outside of outer screen 56 to catch filtered kelp liquor 52.

With reference to FIG. 4, in one or more aspects of the present disclosure kelp processing apparatus 20 includes faceplate 80. Faceplate 80 is urged against outlet 72 and outlet wall 73. In one or more aspects of the present disclosure, during operation of kelp processing apparatus 20 faceplate 80 is urged against outlet 72 and outlet wall 73. Faceplate 80 is configured so that shaft 40 passes through it. In one or more aspects of the present disclosure, faceplate 80 comprises high-molecular-weight plastic. As kelp 36 is urged out of outlet 72, it may adhere to spinning shaft 40 and drop into a container. Kelp 36 may also exit outlet 72, be pressed against faceplate 80, and fall down.

In one or more aspects of the present disclosure, the PSI that faceplate 80 is

urged against outlet wall 73 may be increased or decreased during operation. The adjustment of the PSI allows for kelp 36 to exit outlet 72, be pressed against faceplate 80, and fall rather than adhering to shaft 40. If the pressure is too high, kelp 36 may not be able to exit outlet 72. In one or more aspects of the present disclosure, face plate 80 may be pressed against outlet wall 73 at a pressure from about 1 to 100 PSI, in other aspects from about 15 to 75 PSI, in other aspects from about 15 to 30 PSI, in other aspects at about 30 PSI.

In one or more aspects of the present disclosure, the rotation of shaft 40 may be adjusted to a higher or lower hertz. The hertz of shaft 40 changes the pressure that kelp 36 is pressed through outlet 72 and against faceplate 80. In one or more aspects of the present disclosure, shaft 40 turns at about 20 to 70 hertz, in other aspects at about 25 to 60 hertz, in other aspects at about 25 to 35 hertz, in other aspects at about 30 hertz.

A method for processing kelp is now disclosed. Adding kelp 36 into material chamber 30; urging kelp 36 forward with shaft 40 with threads 44; pressing kelp 36 against at least one tooth 59, thread 44, shaft 40, and perforated screen 52 to create kelp liquor 52; collecting kelp liquor 52; optionally repeatedly pressing kelp 36 and collecting; urging kelp 36 through outlet 72; and collecting press cake 50. It is to be understood that some steps may be added or subtracted and still result in creating press cake 50 and kelp liquor 52. In one or more aspects of the present disclosure, press cake 50 and kelp liquor 52 are processed without any chemicals, in one or more aspects, solely using mechanical means.

Kelp processing apparatus 20 may be able to reverse the direction that shaft spins. If kelp 36 is not pushing out of outlet 72, this step may be done to fix this. A user can use a controller for kelp processing apparatus 20 to make shaft 40 reverse its spin so that kelp 36 is not pushed forward through the filtering process, then the user changes the direction shaft 40 back to pushing kelp 36 forward. This re-presses kelp 36 through outlet 72. This step may potentially allow kelp 36 to exit outlet 72.

Kelp processing apparatus 20 may be able to operate without faceplate 80 pressing against outlet wall 73. In some situations, kelp 36 is not exiting outlet 72; it is stuck. A user can remove faceplate 80 from outlet wall 73 and instruct kelp processing apparatus 20 to turn shaft 40. This will push kelp 36 out of outlet 72 now that there is no faceplate 80 to prevent this.

Kelp is often processed into a dry product or even a dry food product. One discovery of the present disclosure is the ability of the disclosed method to filter kelp with high efficiency to create press cake 50 and kelp liquor 52.

In one or more aspects of the present disclosure, press cake 50, as measured after processing, is from about 50% to about 60% of the weight of kelp 36 that was added into material chamber 30, in another aspect about 56%. In one or more aspects of the present disclosure, kelp liquor 52 is from about 50% to about 40% of the weight of kelp 36 that was added into material chamber 30 and processed, in another aspect about 44%. It is understood that sometimes the percentages will not sum to 100% as some material is not collected. Rather, it is stuck to processing parts.

One of the discoveries in this present disclosure is that the iodine content of kelp can be significantly reduced using only mechanical means. In one or more aspects of the present disclosure, press cake 50 may have an iodine content that is from about 60% to about 67%, in other aspects from about 60% to about 63%, where the iodine content is based on the weight of iodine in press cake 50 versus the weight of the unprocessed kelp. In one or more aspects of the present disclosure, the iodine content in press cake 50 may be about 61%.

In one or more aspects of the present disclosure, kelp liquor 52 may have an iodine content that is from about 40% to about 33%, in other aspects from about 40% to about 37%, where the iodine content is based on the weight of iodine in kelp liquor 52 versus the weight of the unprocessed kelp. In one or more aspects of the present disclosure, the iodine content in kelp liquor 52 may be about 39%. Iodine percent may be measured by an iodide ion-selective electrode (for example, an Iodide Combination Ion Selective Electrode from Hanna Instruments, Woonsocket, Rhode Island), gas chromatography, gas chromatography-electron capture detector, or the Wijs method as discussed in Hydrogenation of Fats and Oils, H. B. W. Patterson, (2nd edition), 2011. It is understood that sometimes the percentages of iodine content will not sum to 100% as some material is not collected. Rather, it is stuck to processing parts. In one or aspects of the present disclosure, the iodine content is based on the weight of iodine in kelp liquor 52 versus the weight of the unprocessed kelp of the type Laminaria saccharina, in other aspects the type is Sacharrina latissimi, Alaria escuelenta, Alaria marginate, Macrocystis pyrifera, Nereocystis luetkeana, Palmaria palmata, Ulva lobata, Laminaria japonica, or Saccharina japonica, or a combination of these kelp types.

Numerous aspects have been described, hereinabove. It will be apparent to those skilled in the art that the above methods and apparatuses may incorporate changes and modifications without departing from the general scope of the present disclosure. It is intended to include all such modifications and alterations in so far as they come within the scope of the appended claims or the equivalents thereof.

I/we claim:

1. An apparatus for processing kelp comprising:
a chamber, a stripper peg inside the material chamber, a shaft, wherein a portion of the shaft has threads for urging kelp forward, a perforated screen connected to the material chamber, and at least one tooth disposed inside the perforated screen.

2. The kelp processing apparatus of claim 1, wherein the perforated screen has a porosity from about 0.033 to 0.050 inches.

3. The kelp processing apparatus of claim 1, further comprising a screen with a smaller porosity than the perforated screen positioned outside of and encompassing the perforated screen.

4. The kelp processing apparatus of claim 1, wherein at least one shaft thread has a notch on the outside edge of the thread.

5. A method for processing kelp comprising:
adding kelp into a chamber;
moving the kelp to be positioned inside a perforated screen; and
pressing the kelp against at least one tooth, at least one thread, at least one shaft, and at least one perforated screen.

6. The kelp processing method of claim 5, further comprising collecting a kelp cake.

7. The kelp processing method of claim 5, further comprising collecting a kelp liquor.

8. The kelp processing method of claim 5, further comprising shredding the kelp in the chamber.

9. The kelp processing method of claim 5, further comprising injecting steam into the perforated screen.

10. The kelp processing method of claim 5, further comprising at least partially cooking the kelp while it passes through the perforated screen.

11. The kelp processing method of claim 5, wherein the kelp processing method yields kelp cake comprising 45%-50% iodine.

12. A mechanically processed kelp composition comprising:
a cake, wherein the cake has from about 60% to about 67% iodine, wherein the iodine content is based on the weight of iodine in the press cake versus the weight of an unprocessed kelp.

13. The kelp composition of claim 12, wherein the cake has about 61% iodine.

14. The kelp composition of claim 12, the cake further comprising from about 50% to about 60% of the weight of the unprocessed kelp.

15. The kelp composition of claim 12, the cake further comprising about 56% of the weight of the unprocessed kelp.

16. The kelp composition of claim 12, wherein the cake comprises at least one of Laminaria saccharina, Sacharrina latissimi, Alaria escuelenta, Alaria marginate, Macrocystis pyrifera, Nereocystis luetkeana, Palmaria palmata, Ulva lobata, Laminaria japonica, and Saccharina japonica.

17. The kelp composition of claim 12, wherein the cake essentially consists of Laminaria saccharina.

18. The kelp composition of claim 12, the cake further comprising from about 50% to about 60% of the weight of the unprocessed kelp, and wherein the cake comprises at least one of Laminaria saccharina, Sacharrina latissimi, Alaria escuelenta, Alaria marginate, Macrocystis pyrifera, Nereocystis luetkeana, Palmaria palmata, Ulva lobata, Laminaria japonica, and Saccharina japonica.
